(19) United States
(12) Patent Application Publication
(10) Pub. No.: US 2014/0362127 A1
(43) Pub. Date: Dec. 11, 2014

(54) DISPLAY DEVICE, PIXEL ARRAY, AND COLOR COMPENSATING METHOD

(71) Applicant: AU Optronics Corporation, Hsin-chu (TW)

(72) Inventors: Hsueh-Yen YANG, HSIN-CHU (TW); Hong-Shen LIN, HSIN-CHU (TW)

(73) Assignee: AU Optronics Corporation, Hsin-chu (TW)

(21) Appl. No.: 14/151,194

(22) Filed: Jan. 9, 2014

(30) Foreign Application Priority Data
Jun. 11, 2013 (TW) 102120741

(51) Int. Cl. G09G 3/20

(52) U.S. Cl. CPC G09G 3/2003
USPC 345/690; 345/55

(57) ABSTRACT

A pixel array includes a first pixel and a second pixel. The pixels are disposed adjacent to each other and jointly include six sub-pixels. The sub-pixels include one red sub-pixel, two green sub-pixels, one blue sub-pixel, and two fourth color sub-pixels. The pixel area configuration of the first pixel is the same as the pixel area configuration of the second pixel, and the order of the sub-pixel areas disposed therein is, sequentially, a first sub-pixel area, a second sub-pixel area and a third sub-pixel area. The red sub-pixel is disposed in the first sub-pixel area of the first pixel, and the blue sub-pixel is disposed in to the first sub-pixel area of the second pixel. Furthermore, a display device and a color compensating method are also disclosed herein.

### RELATED APPLICATIONS

This application claims priority to Taiwan Application Serial Number 102120741, filed Jun. 11, 2013, which is herein incorporated by reference.

### BACKGROUND

1. Field of Invention

The embodiment of the present invention relates generally to a device and a method, and, more particularly, to a display device, a pixel array and a color compensating method.

2. Description of Related Art

With the advancement of science and technology, consumer demand for high display quality is ever increasing. Accordingly, to improve display quality, the size of the unit pixel must be reduced.

However, according to the conventional arrangement, four sub-pixels are disposed in one pixel, and such an arrangement results in an increased use of area, and therefore, the size of the unit pixel cannot be effectively reduced.

In view of the foregoing, there are inconveniences and disadvantages associated with prior solutions that require improvement. There has been much effort in trying to find a solution to the aforementioned problems. Nonetheless, there is still a need to improve the existing apparatuses and techniques in the art.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

A display device, a pixel array and a color compensating method are provided, which address the problems faced by the prior art.

One aspect of the embodiment of the present invention is to provide a pixel array, which comprises a first pixel and a second pixel, wherein the first and second pixels are disposed adjacent to each other, and jointly comprise six sub-pixels. The sub-pixels comprise one red sub-pixel, two green sub-pixels, one blue sub-pixel and two fourth color sub-pixels. The pixel area configuration of the first pixel is the same as the pixel area configuration of the second pixel, and the order of the sub-pixel areas disposed therein is, sequentially, a first sub-pixel area, a second sub-pixel area and a third sub-pixel area. The red sub-pixel is disposed in the first sub-pixel area of the first pixel, whereas the blue sub-pixel is correspondingly disposed in the first sub-pixel area of the second pixel.

Another aspect of the embodiment of the present invention is to provide a display device, which comprises a pixel array, a first to a third driver, a sub-pixel colored circuit and a multiplexer. Specifically, the pixel array comprises a sub-pixel set and a first to a third column, the sub-pixel colored circuit comprises a first to a fourth output terminal, and the multiplexer comprises an input terminal and an output terminal. The first, second and third drivers are respectively and electrically connected to the first, second and third columns of the pixel array; the first and second output terminals of the sub-pixel colored circuit are respectively and electrically connected to the second and third drivers; the third and fourth output terminals of the sub-pixel colored circuit are electrically connected to the input terminal of the multiplexer; and an output terminal of the multiplexer is electrically connected to the first driver.

Yet another aspect of the embodiment of the present invention is to provide a color compensating method suitable for use in the above-discussed pixel array, and the color compensating method comprises the steps of:

when the first pixel of the pixel array is designated to display the blue color, using the blue sub-pixel of the second pixel to display the blue color in a compensatory way; and

when the second pixel of the pixel array is designated to display the red color, using the red sub-pixel of the first pixel to display the red color in a compensatory way.

In view of the foregoing, the embodiments of the present disclosure provide a display device, a pixel array and a color compensating method, in which an improvement is realized with respect to the inability to effectively reduce unit pixel size encountered by the conventional arrangement involving four sub-pixels in one unit pixel.

Many of the attendant features and advantages of the present disclosure will become better understood with reference to the following detailed description considered in connection with the accompanying drawings.

### BRIEF DESCRIPTION OF THE DRAWINGS

The invention can be more fully understood by reading the following detailed description of the embodiments, with reference made to the accompanying drawings as follows:

FIG. 1A schematically shows a pixel array according to one embodiment of the present disclosure;

FIG. 1B schematically shows an operation mode of a first pixel of the pixel array according to one embodiment of the present disclosure;

FIG. 1C schematically shows an operation mode of a second pixel of the pixel array according to one embodiment of the present disclosure;

FIG. 1D schematically shows a compensating algorithm of a pixel array according to one embodiment of the present disclosure;

FIG. 1E schematically shows a pixel array according to one embodiment of the present disclosure;

FIG. 1F schematically shows a pixel array according to one embodiment of the present disclosure;

FIG. 1G schematically shows an operation of a first pixel of the pixel array according to one embodiment of the present disclosure;

FIG. 1H schematically shows an operation of a second pixel of the pixel array according to one embodiment of the present disclosure;

FIG. 2A schematically shows a pixel array according to another embodiment of the present disclosure;

FIG. 2B schematically shows an operation mode of a first pixel of the pixel array according to one embodiment of the present disclosure;

FIG. 2C schematically shows an operation mode of a second pixel of the pixel array according to one embodiment of the present disclosure;

FIG. 2D schematically shows a pixel array according to another embodiment of the present disclosure;

FIG. 2E schematically shows a pixel array according to another embodiment of the present disclosure a pixel array;

FIG. 2F schematically shows an operation of a first pixel of the pixel array according to one embodiment of the present disclosure;

FIG. 2G schematically shows an operation of a second pixel of the pixel array according to one embodiment of the present disclosure;

FIG. 3A schematically shows a pixel array according to yet another embodiment of the present disclosure;

FIG. 3B schematically shows an operation of a first pixel of the pixel array according to one embodiment of the present disclosure;

FIG. 3C schematically shows an operation of a second pixel of the pixel array according to one embodiment of the present disclosure;

FIG. 3D schematically shows a pixel array according to yet another embodiment of the present disclosure;

FIG. 4A schematically shows a pixel array according to still another embodiment of the present disclosure;

FIG. 4B schematically shows an operation of a first pixel of the pixel array according to one embodiment of the present disclosure;

FIG. 4C schematically shows an operation of a second pixel of the pixel array according to one embodiment of the present disclosure;

FIG. 4D schematically shows a pixel array according to still another embodiment of the present disclosure;

FIG. 5 schematically shows a display device according to one embodiment of the present disclosure; and

FIG. 6 is a flow chart illustrating a color compensating method according to an embodiment of the present disclosure.

In accordance with common practice, the various described features/elements are not drawn to scale but instead are drawn to best illustrate specific features/elements relevant to the present invention. Also, like reference numerals and designations in the various drawings are used to indicate like elements/parts.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

Unless otherwise defined herein, scientific and technical terminologies employed in the present disclosure shall have the meanings that are commonly understood and used by one of ordinary skill in the related art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

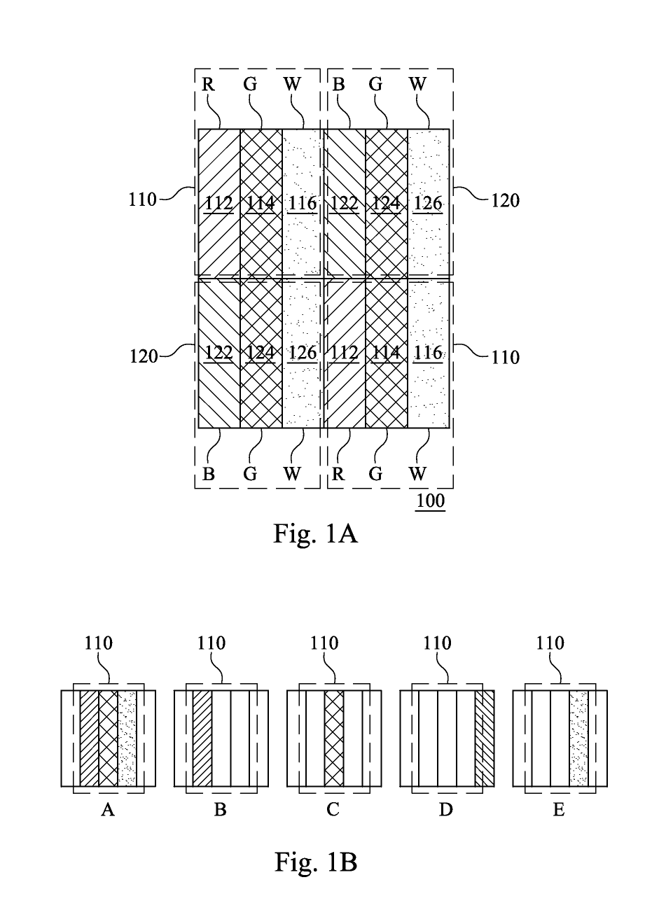

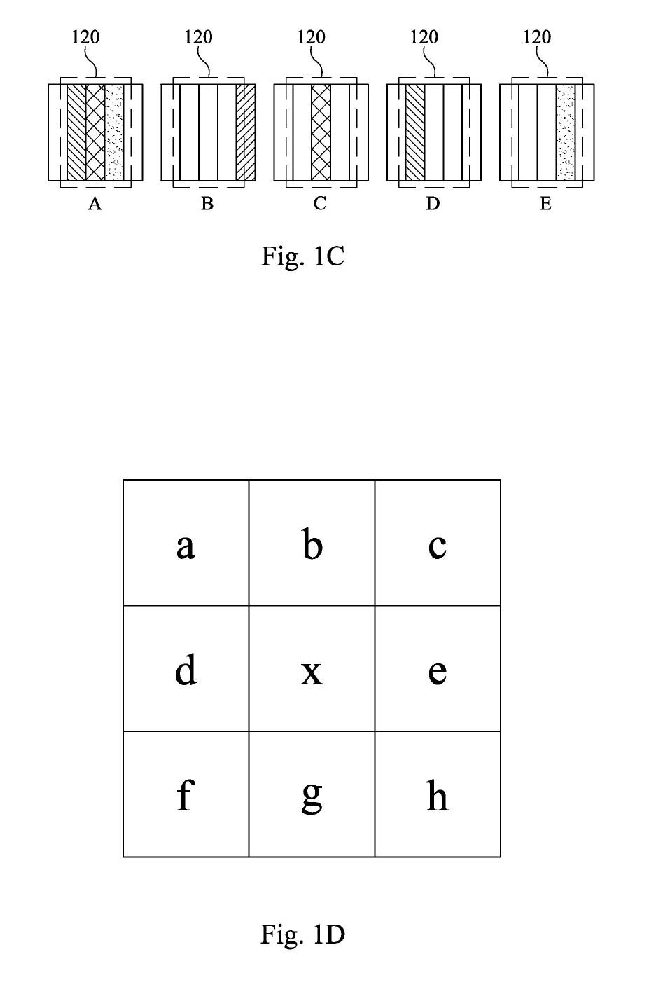

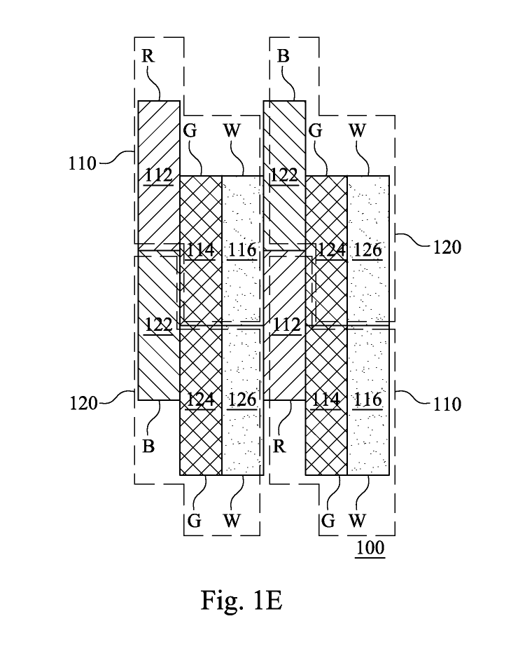

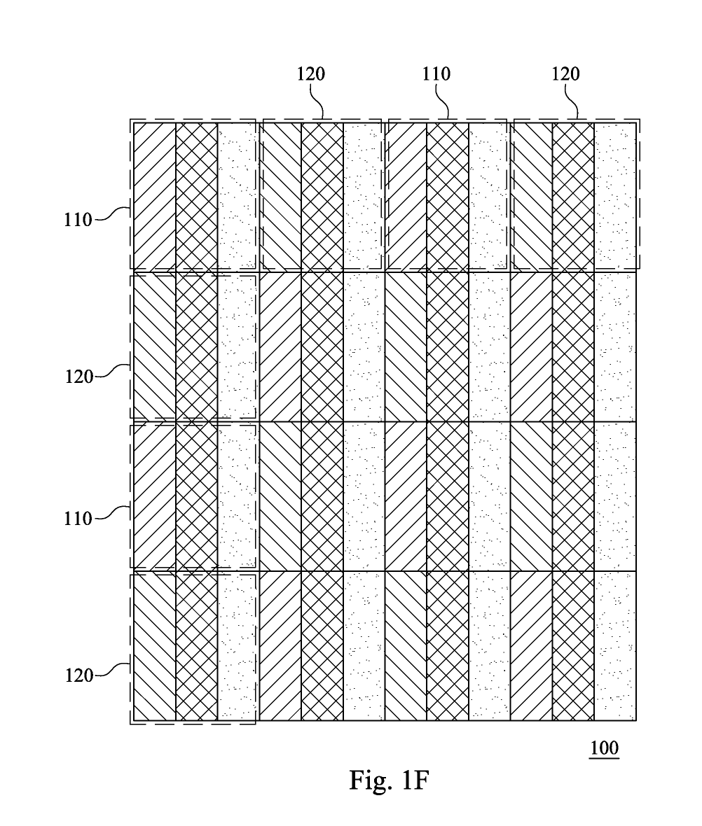

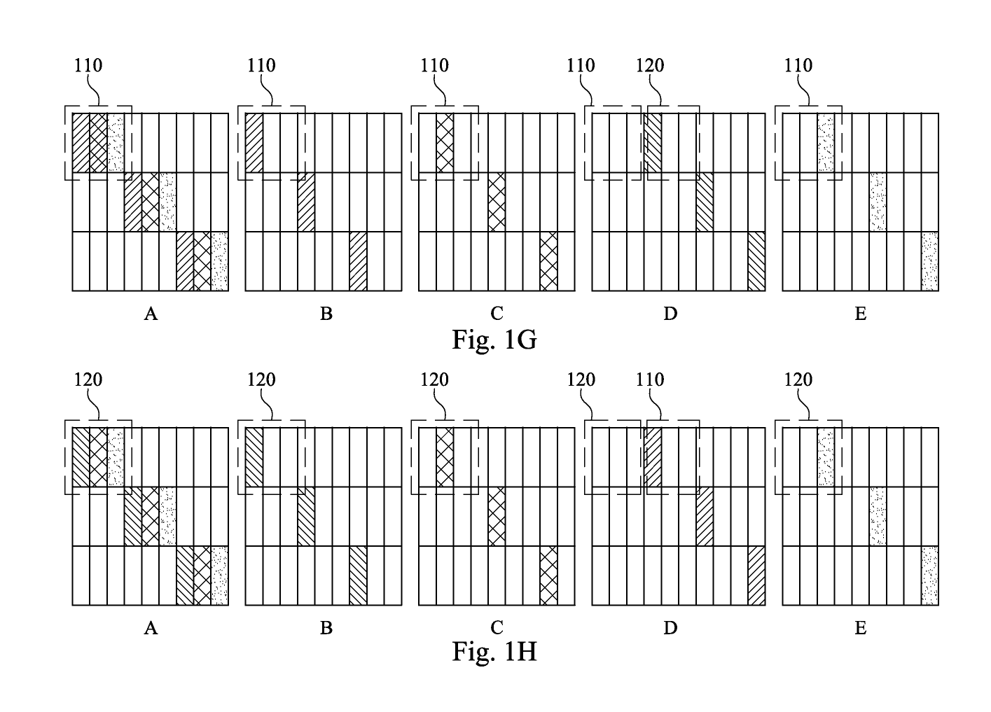

To address the problem(s) faced by the prior art, the present disclosure provides a pixel array with an innovative configuration in which only three sub-pixels are disposed in a unit pixel, thereby effectively reducing the size of the unit pixel. FIG. 1A schematically illustrates a pixel array 100 according to one embodiment of the present disclosure.

As illustrated in FIG. 1A, the pixel array 100 comprises a first pixel 110 and a second pixel 120 that are disposed adjacent to each other and jointly comprise six sub-pixels. Said six sub-pixels comprise one red sub-pixel R, two green sub-pixels G, one blue sub-pixel B and two fourth color sub-pixels W. With respect to configuration, the sub-pixel areas of the first pixel 110 are arranged the same as the sub-pixel areas of the second pixel 120, in which the order of the sub-pixel areas is, sequentially, a first sub-pixel area 112, 122, a second sub-pixel area 114, 124 and a third sub-pixel area 116, 126. In the pixel array 100, the red sub-pixel R is disposed in the first sub-pixel area 112 of the first pixel 110, and the blue sub-pixel B is disposed in the first sub-pixel area 122 of the second pixel 120. Moreover, one of the green sub-pixels G is disposed in the second sub-pixel area 114 of the first pixel 110, and the other one of the green sub-pixels G is disposed in the second sub-pixel area 124 of the second pixel 120. Finally, one of the fourth color sub-pixels W is disposed in the third sub-pixel area 116 of the first pixel 110, and the other one of the fourth color sub-pixels W is disposed in the third sub-pixel area 126 of the second pixel 120. However, the present disclosure is not limited to the configuration shown in FIG. 1A, and persons having ordinary skill in the art may selectively arrange the above-mentioned sub-pixels depending on actual needs.

For the purpose of discussion, FIG. 1B is provided as an example to explain an operation of the first pixel 110 of the pixel array 100 according to the present disclosure, in which first pixel 110 of the pixel array 100 is used to display different monochromes. In FIG. 1B, part A illustrates the arrangement of the sub-pixels of the first pixel 110, and the sub-pixels preceding and succeeding the first pixel 110 belong to the second pixels 120.

First, with reference to part B, when the first pixel 110 is designated to display the red color, it uses the red sub-pixel R to display the red color. Next, with reference to part C, when the first pixel 110 is designated to display the green color, it uses the green sub-pixel G to display the green color. Subsequently with reference to part D, when the first pixel 110 is designated to display the blue color, since the first pixel 110 itself does not comprise a blue sub-pixel B, in this case, the second pixel 120 which is disposed adjacent to the first pixel 110 uses the blue sub-pixel B of the second pixel 120 to display the blue color in a compensatory way. Further, with reference to part E, when the first pixel 110 is designated to display a fourth color (such as the white color), it uses the fourth color sub-pixel W to display the fourth color.

Similarly, to describe the operation of the second pixel 120 of the pixel array 100 according to the present disclosure, FIG. 1C is provided as an illustration, in which the second pixel 120 of the pixel array 100 is used to display different monochromes. In FIG. 1C, part A illustrates the arrangement of the sub-pixels of the second pixel 120, and the sub-pixels preceding and succeeding the second pixel 120 belong to the first pixels 110.

Since the color displaying mode illustrated in FIG. 1C is similar to that of FIG. 1B, only the difference presented in FIG. 1C is discussed herein for the sake of brevity. With reference to part B, when the second pixel 120 is designated to display the red color, since the second pixel 120 itself does not comprise a red sub-pixel R, in this case, the first pixel 110 which is disposed adjacent to the second pixel 120 uses the red sub-pixel R of the first pixel 110 to display the red color in a compensatory way.

In view of the foregoing, by using the innovative arrangement of the pixel array 100, only three sub-pixels are required in a unit pixel, thereby effectively reducing the size of the unit pixel and hence improving the precision of the display device, so as to improve the display quality of the display device. Additionally, although there is no blue sub-pixel B disposed in the first pixel 110, the second pixel 120 adjacent to the first pixel 110 has the blue sub-pixel B disposed therein; accordingly, when the first pixel 110 is designated to display the blue color, the second pixel 120 is used to display the blue color (see part D of FIG. 1B). Similarly, although there is no red sub-pixel R disposed in the second pixel 120, when the second pixel 120 is designated to display the red color, the first pixel 110 is used to display the red color (see part B of FIG. 1C). In this way, even if there are only three sub-pixels disposed in a unit pixel, the pixel array 100 according to the present disclosure may still display the image precisely, thereby maintaining the display quality of the display device.

Regarding the instances in which the first pixel 110 requires an adjacent second pixel 120 to display a color in a compensatory way, or the second pixel 120 requires an adjacent first pixel 110 to display a color in a compensatory way, a discussion is provided herein below.

First, an image input driving device (not shown in the drawings) uses a line buffer (not shown in the drawings) built in a timing controller of the driving to device to temporarily store three lines based on an image; subsequently, a 3-by-3 (3*3) array is obtained based on said three lines in which each array information represents one pixel information. Said array is illustrated in FIG. 1D. Next, a computation is performed according to the following algorithm:

$$\{ \begin{matrix}S 1 = a - x \\ S 2 = d - x \\ S 3 = f - x\end{matrix} \{ \begin{matrix}S 4 = c - x \\ S 5 = e - x \\ S 6 = h - x\end{matrix} \{ \begin{matrix}S 7 = b - x \\ S 8 = g - x\end{matrix}$$

After the values S1 to S8 are computed per the algorithm above, the values of S1 to S8 are sent to the driving device (not shown in the drawings) for analysis and computation, and a determination of whether to perform the color compensation is made based on the analysis and computation results. Specifically, from the values of S1 to S8, it is possible to know if an edge is present between each point of the 3*3 array and the center point x. Next, the driving device (not shown in the drawings) further determines whether the edge falls within a default edge value; if a positive determination is made at this point, color compensation is performed. It should be noted that said color compensation includes one pixel providing the color of its own sub-pixels to compensate for another pixel, or one pixel borrowing the color of a sub-pixel from another pixel to compensate for the color of said pixel.

In one embodiment, with reference to FIG. 1A, the sub-pixels of the first pixel 110 are disposed in the order of the red sub-pixel R, the green sub-pixel G and the fourth color sub-pixel W, whereas the sub-pixels of the second pixel 120 are disposed in the order of the blue sub-pixel B, the green sub-pixel G and the fourth color sub-pixel W. Moreover, as illustrated in FIG. 1A, the first pixel 110 and the second pixel 120 are disposed in a same row or a same column of the pixel array 100. For the implementation of the present disclosure, the fourth color sub-pixel W may be a white sub-pixel; however, the present disclosure is not limited thereto, and persons having ordinary skill in the art may selectively choose a sub-pixel of any particular color for the fourth color sub-pixel W.

To further address the problems existing in the prior art, embodiments of the present disclosure further provide another configuration of the pixel array 100, as illustrated in FIG. 1E. As shown, the first sub-pixel area 112 and the second sub-pixel area 114 of the first pixel 110 are spaced by a half pitch. Additionally, the first sub-pixel area 122 and the second sub-pixel area 124 of the second pixel 120 are also spaced by a half pitch. However, the present disclosure is not limited to FIG. 1E, and persons having ordinary skill in the art may selectively dispose the plurality of sub-pixel areas of the first pixel 110 and the second pixel 120 using other configurations. It should be noted that the operating method of the pixel array 100 illustrated in FIG. 1E is similar to that of the pixel array 100 illustrated in FIG. 1A, and hence, reference should be made to the discussion related to FIGS. 1B and 1C for the operating method of the pixel array 100 in FIG. 1E.

FIG. 1F schematically shows a pixel array 100 according to one embodiment of the present disclosure. As illustrated, the pixel array 100 further comprises a plurality of first pixels 110 and a plurality of second pixels 120, wherein the plurality of first pixels 110 are repeatedly and alternately disposed in a same row or a same column, and the plurality of second pixels 120 are repeatedly and alternately disposed in a same row or a same column. It should be noted that the pixel array 100 illustrated in FIG. 1E can be disposed according to the arrangement shown in FIG. 1F.

To describe the operation of the first pixel 110 of the pixel array 100 according to the present disclosure, reference is made to FIG. 1G, in which the first pixel 110 of the pixel array 100 is used to display various color lines. As in the case of the configuration shown in FIG. 1B, in FIG. 1G, part A illustrates the arrangement of the sub-pixels of the first pixel 110, and the sub-pixels preceding and succeeding the first pixel 110 belong to the second pixels 120.

First, with reference to part B, when the first pixel 110 is designated to display the red color, it uses the red sub-pixel R to display the red color, and all the first pixels 110 on a diagonal line display the red color such that the pixel array 100 is used to display a red color line. Next, with reference to part C and part E, when the first pixel 110 is designated to display the green color or the fourth color, the display method is similar to that used for displaying the red color, and hence, a detailed discussion thereof is omitted herein. Subsequently, with reference to part D, when the first pixel 110 is designated to display the blue color, since the first pixel 110 itself does not comprise a blue sub-pixel B, in this case, the second pixel 120 which is disposed adjacent to the first pixel 110 uses the blue sub-pixel B of the second pixel 120 to display the blue color in a compensatory way, and all the second pixels 120 on a diagonal line display the blue color such that the pixel array 100 displays a blue color line even when the first pixel 110 does not comprise a blue sub-pixel. Additionally, since the first pixel 110 and the second pixel 120 are disposed adjacent to each other, users perceive little or no difference.

Similarly, to describe the operation of the second pixel 120 of the pixel array 100 according to the present disclosure, reference is made to FIG. 1H, in which the pixel array 100 is used to display various color lines. As in the case of the configuration shown in FIG. 1G, in FIG. 1H, part A illustrates the arrangement of the sub-pixels of the first pixel 110, and a 9-by-9 array consisting of first pixels 110 and second pixels 120 are illustrated for the purpose of discussion.

Since the color displaying mode illustrated in FIG. 1H is similar to that of FIG. 1G, only the difference presented in FIG. 1H is discussed herein for the sake of brevity. With reference to part D, when the second pixel 120 is designated to display the red color, since the second pixel 120 itself does not comprise a red sub-pixel R, in this case, the first pixel 110 which is disposed adjacent to the second pixel 120 uses the red sub-pixel R of the first pixel 110 to display the red color in a compensatory way, and all the first pixels 110 on a to diagonal line display the red color such that the pixel array 100 is used to display a red color line. Hence, the pixel array 100 may still display a red line even when the second pixel 120 does not comprise a red sub-pixel R. Similarly, since the first pixel 110 and the second pixel 120 are disposed adjacent to each other, users perceive little or no difference.

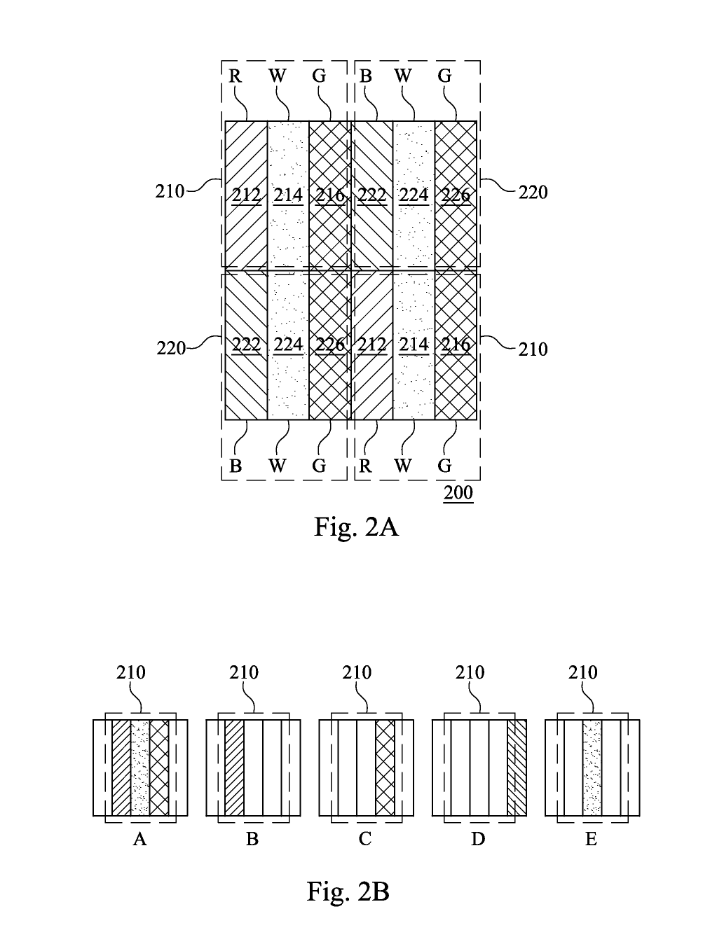

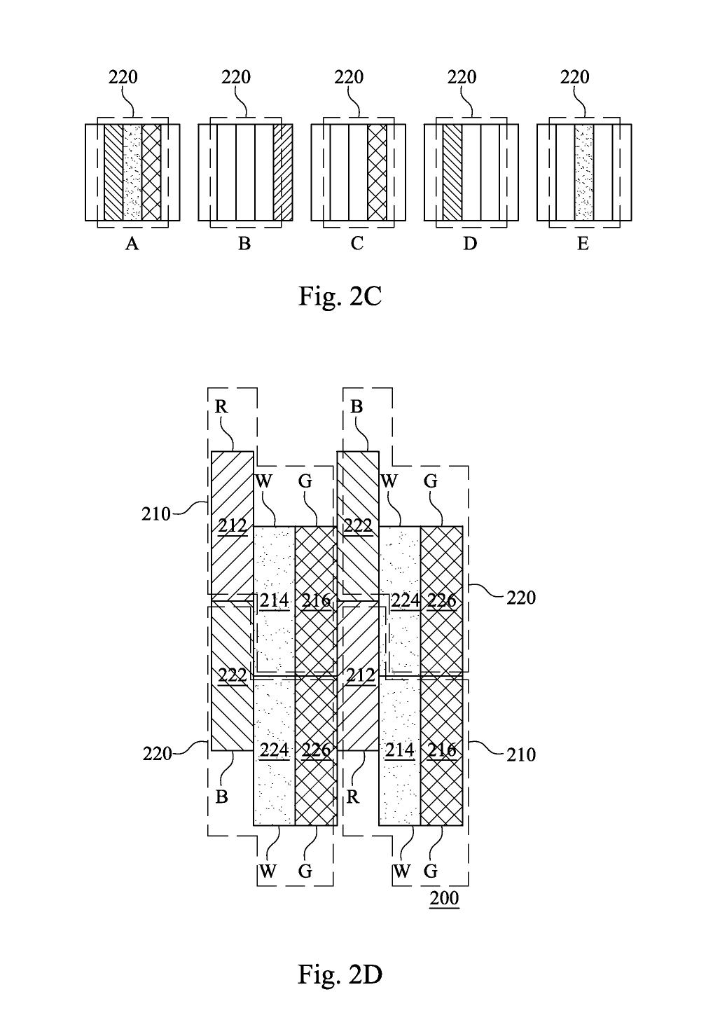

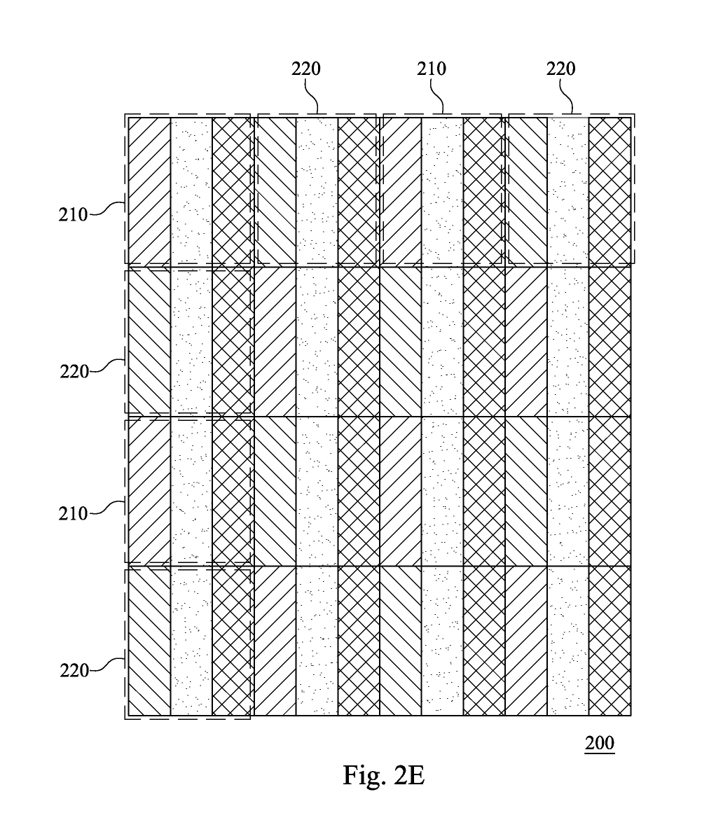

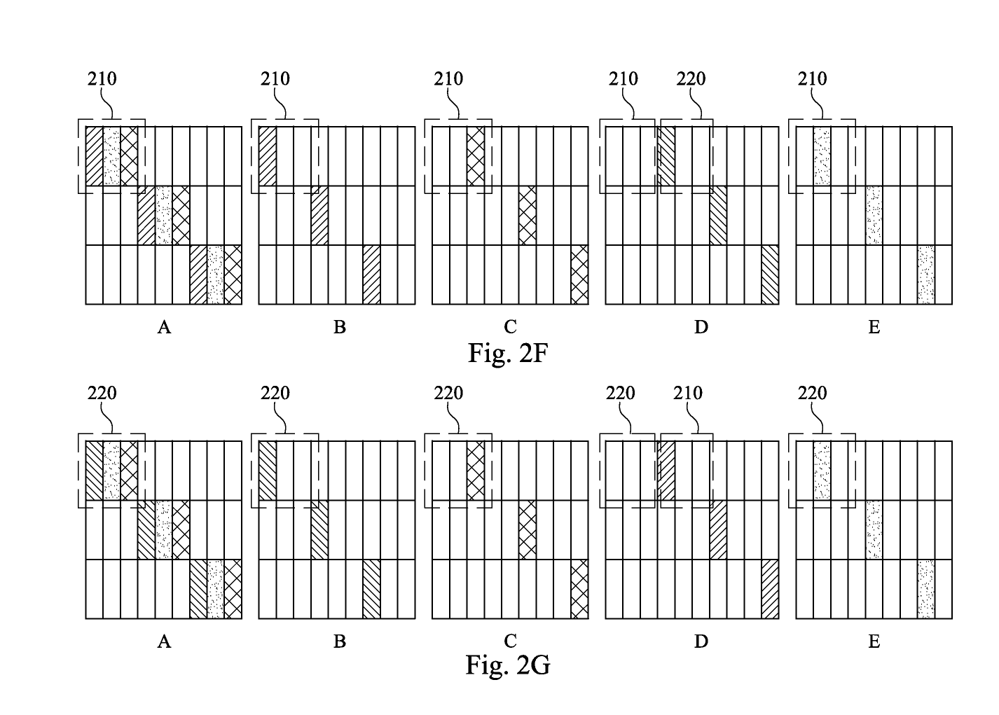

Embodiments of the present disclosure further provide a configuration of another pixel array 200, as illustrated in FIG. 2A. As shown, the first pixel 210 comprises sub-pixels in the order of a red sub-pixel R, a fourth color sub-pixel W and a green sub-pixel G, whereas the second pixel 220 comprises sub-pixels in the order of a blue sub-pixel B, a fourth color sub-pixel W and a green sub-pixel G. Additionally, as illustrated in FIG. 2A, the first pixel 210 and the second pixel 220 are disposed in a same row or a same column of the pixel array 200.

For the purpose of discussion, FIG. 2B is provided as an example to explain the operation of the first pixel 210 of the pixel array 200 according to the present disclosure, in which first pixel 210 of the pixel array 200 is used to display different monochromes. FIG. 2B is similar to FIG. 1B, with the exception that the positions of the green sub-pixel G and the fourth color sub-pixel W are interchanged in FIG. 2B. Additionally, it should be noted that in part D, when the first pixel 210 is designated to display the blue color, since the first pixel 210 itself does not have a blue sub-pixel B, in this case, the second pixel 220 adjacent to said first pixel 210 uses the blue sub-pixel B of the second pixel 220 to display the blue color in a compensatory way.

Similarly, to describe the operation of the second pixel 220 of the pixel array 200 according to the present disclosure, FIG. 2C is provided as an illustration, in which the second pixel 220 of the pixel array 200 is used to display different monochromes. It should be noted that FIG. 2C is similar to FIG. 1C, with the exception that the positions of the green sub-pixel G and the fourth color sub-pixel W are interchanged in FIG. 2C. Additionally, it should be noted that in part B, when the second pixel 220 is designated to display the red color, since the second pixel 220 itself does not have a red sub-pixel R, in this case, the first pixel 210 adjacent to said second pixel 220 uses the red sub-pixel R of the first pixel 210 to display the red color in a compensatory way. It should be noted that since the first pixel 210 and the second pixel 220 are disposed adjacent to each other, users perceive little or no difference.

To further resolve the problem(s) encountered by the prior art, embodiments of the present disclosure further provide another configuration of the pixel array 200, as illustrated in FIG. 2D. As shown, the first sub-pixel area 212 and the second sub-pixel area 214 of the first pixel 210 are spaced by a half pitch. Additionally, the first sub-pixel area 222 and the second sub-pixel area 224 of the second pixel 220 are also spaced by a half pitch. However, the present disclosure is not limited to FIG. 2D, and persons having ordinary skill in the art may selectively dispose the plurality of sub-pixel areas of the first pixel 210 and the second pixel 220 using other configurations.

It should be noted that the operating method of the pixel array 100 illustrated in FIG. 1E is similar to that of the pixel array 100 illustrated in FIG. 1A, and hence, reference should be made to the discussion related to FIGS. 1B and 1C for the operating method of the pixel array 100 in FIG. 1E.

FIG. 2E schematically shows a pixel array 200 according to one embodiment of the present disclosure. As illustrated, the pixel array 200 further comprises a plurality of first pixels 210 and a plurality of second pixels 220, wherein the plurality of first pixels 210 are repeatedly and alternately disposed in a same row or a same column, and the plurality of second pixels 220 are repeatedly and alternately disposed in a same row or a same column. It should be noted that the pixel array 200 illustrated in FIG. 2D can be disposed according to the arrangement shown in FIG. 2E.

To describe the operation of the first pixel 210 of the pixel array 200 according to the present disclosure, FIG. 2F is provided for the purpose of illustration, in which the pixel array 200 is used to display various color lines. It should be noted that FIG. 2F is similar to FIG. 1G, with the exception that the positions of the green sub-pixel G and the fourth color sub-pixel W are interchanged. Additionally, it should be noted that in part D, when the first pixel 210 is designated to display the blue color, since the first pixel 210 itself does not have a blue sub-pixel B, in this case, the second pixel 220 adjacent to said first pixel 210 uses the blue sub-pixel B of the second pixel 220 to display the blue color in a compensatory way, and all the second pixels 220 on a diagonal line display the blue color such that the pixel array 200 can display the blue color line, even if the first pixel 210 itself does not comprise a blue sub-pixel B.

Similarly, to describe the operation of the second pixel 220 of the pixel array 200 according to the present disclosure, FIG. 2G is provided for the purpose of illustration, in which the pixel array 200 is used to display various color lines. It should be noted that FIG. 2G is similar to FIG. 1H, with the exception that the positions of the green sub-pixel G and the fourth color sub-pixel W are interchanged in FIG. 2G. Additionally, it should be noted that in part D, when the second pixel 220 is designated to display the red color, since the second pixel 220 itself does not have a red sub-pixel R, in this case, the first pixel 210 adjacent to said second pixel 220 uses the red sub-pixel R of the first pixel 210 to display the red color in a compensatory way, and all the first pixels 210 on a diagonal line display the red color such that the pixel array 200 can display the red color line, even if the second pixel 220 itself does not comprise a red sub-pixel R. Additionally, since the first pixel 210 and the second pixel 220 are disposed adjacent to each other, users perceive little or no difference.

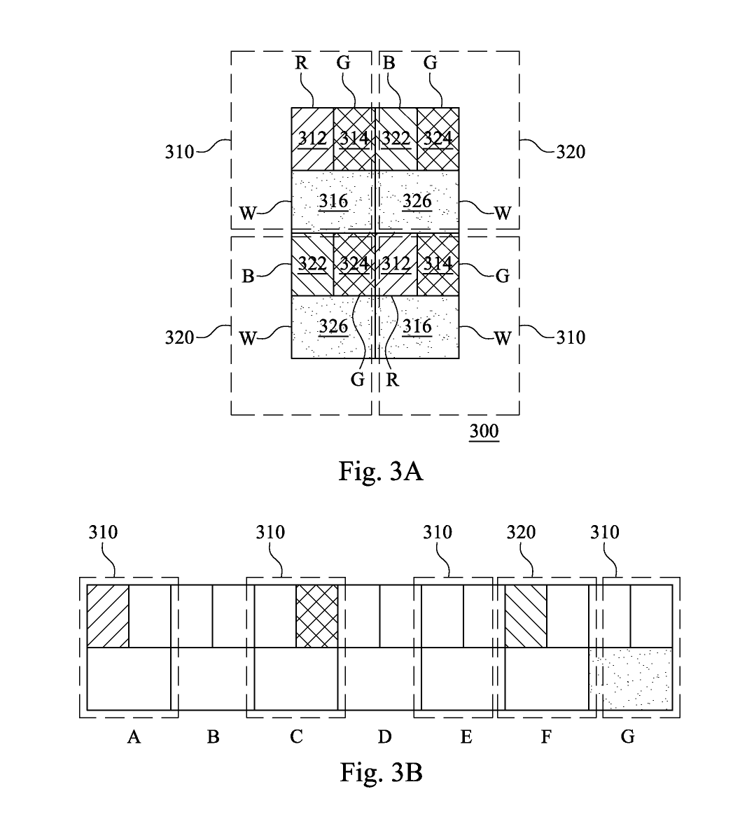

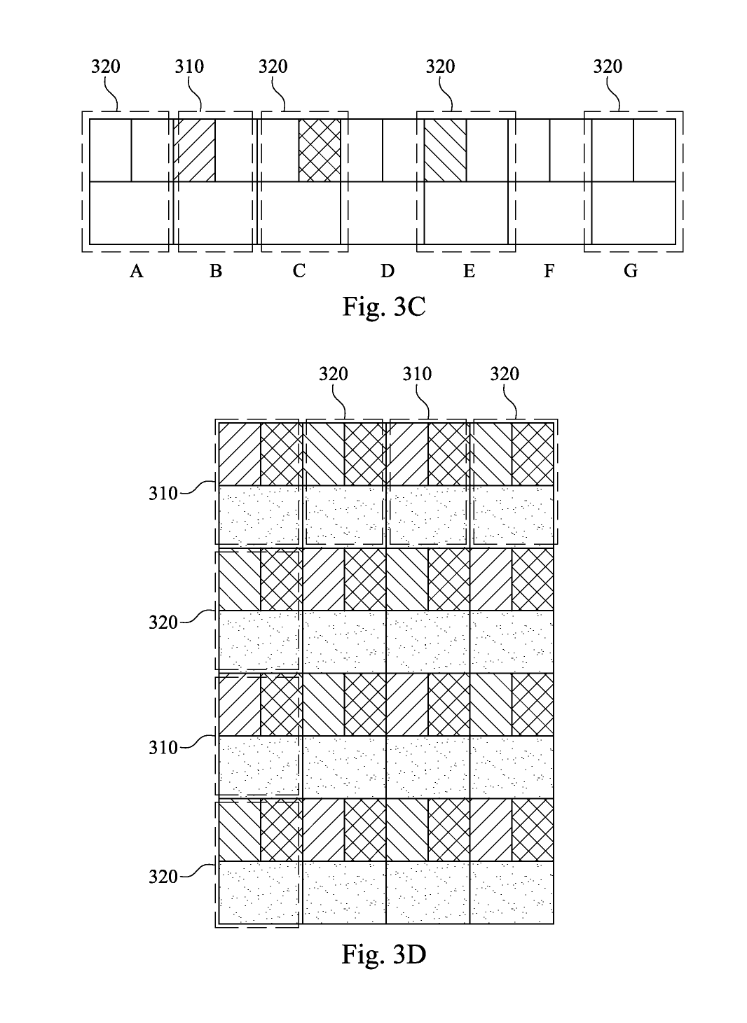

To address the problem(s) faced by the prior art, embodiments of the present disclosure further provide another configuration of the pixel array 300, as illustrated in FIG. 3A. In contrast to the pixel arrays 100 and 200 illustrated in FIG. 1A and FIG. 2A, the first sub-pixel areas 312, 322 and the second sub-pixel areas 314, 324 respectively account for one-fourth of the area of the first pixel 310 and one-fourth the area of the second pixel 320; whereas the third sub-pixel areas 316, 326 account for one-half of the area of the first pixel 310 and the area of the second pixel 320.

In the present embodiment, the first sub-pixel area 312, second sub-pixel area 314 and third sub-pixel area 316 of the first pixel 310 are respectively disposed with a red sub-pixel R, a green sub-pixel G and a fourth color sub-pixel W; whereas the first sub-pixel area 322, second sub-pixel area 324 and third sub-pixel area 326 of the second pixel 320 are respectively disposed with a blue sub-pixel B, a green sub-pixel G and a fourth color sub-pixel W. Additionally, as illustrated in FIG. 3A, the first pixel 310 and the second pixel 320 are disposed in a same row or a same column of the pixel array 300.

To describe the operation of the first pixel 310 of the pixel array 300 according to the present disclosure, FIG. 3B is provided for the purpose of illustration, in which the pixel array 300 is used to display various monochromes. As illustrated in FIG. 3B, parts A, C, E and G belong to the first pixel 310, whereas parts B, D and F belong to the second pixel 320. To facilitate the understanding of the operation of the present embodiment, only sub-pixels that are activated are illustrated herein, while the other non-active sub-pixels are presented as blank structures. With reference to parts A, C and G in FIG. 3B, when the first pixel 310 is designated to display the red color, green or the fourth colors, it may use the red, green and the fourth color sub-pixels R, G, W therewithin to respectively display said colors; however, when the first pixel 310 is designated to display the blue color, since the first pixel 310 itself does not comprise a blue sub-pixel B, in this case, with reference to part F, the second pixel 320 adjacent to the first pixel 310 uses the blue sub-pixel B of the second pixel 320 to display the blue color in a compensatory way.

Reference is now made to FIG. 3C which is used to describe the operation of the second pixel 320 of the pixel array 300 according to the present disclosure, in which parts A, C, E and G belong to the second pixel 320, whereas parts B, D and F belong to the first pixel 310. With reference to parts C, E and G in FIG. 3C, when the second pixel 320 is designated to display the green, blue and fourth colors, it may use the green, blue and the fourth color sub-pixels G, B, W therewithin to respectively display said colors; however, when the second pixel 320 is designated to display the red color, since the second pixel 320 itself does not comprise a red sub-pixel R, in this case, with reference to part B, the first pixel 310 adjacent to the second pixel 320 uses the red sub-pixel R of the first pixel 310 to display the blue color in a compensatory way. It should be noted that, in FIGS. 3B and 3C, since the first pixel 310 and the second pixel 320 are disposed adjacent to each other, users perceive little or no difference.

FIG. 3D schematically shows a pixel array 300 according to one embodiment of the present disclosure. As illustrated, the pixel array 300 further comprises a plurality of first pixels 310 and a plurality of second pixels 320, wherein the plurality of first pixels 310 are repeatedly and alternately disposed in a same row or a same column, and the plurality of second pixels 320 are repeatedly and alternately disposed in a same row or a same column.

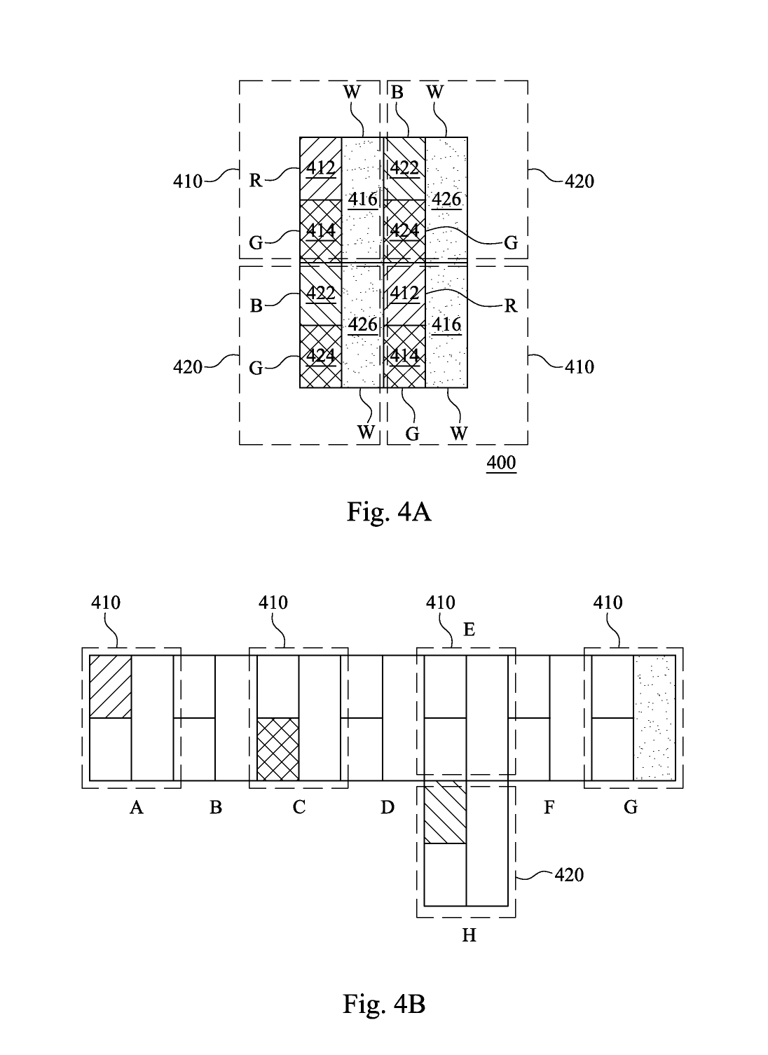

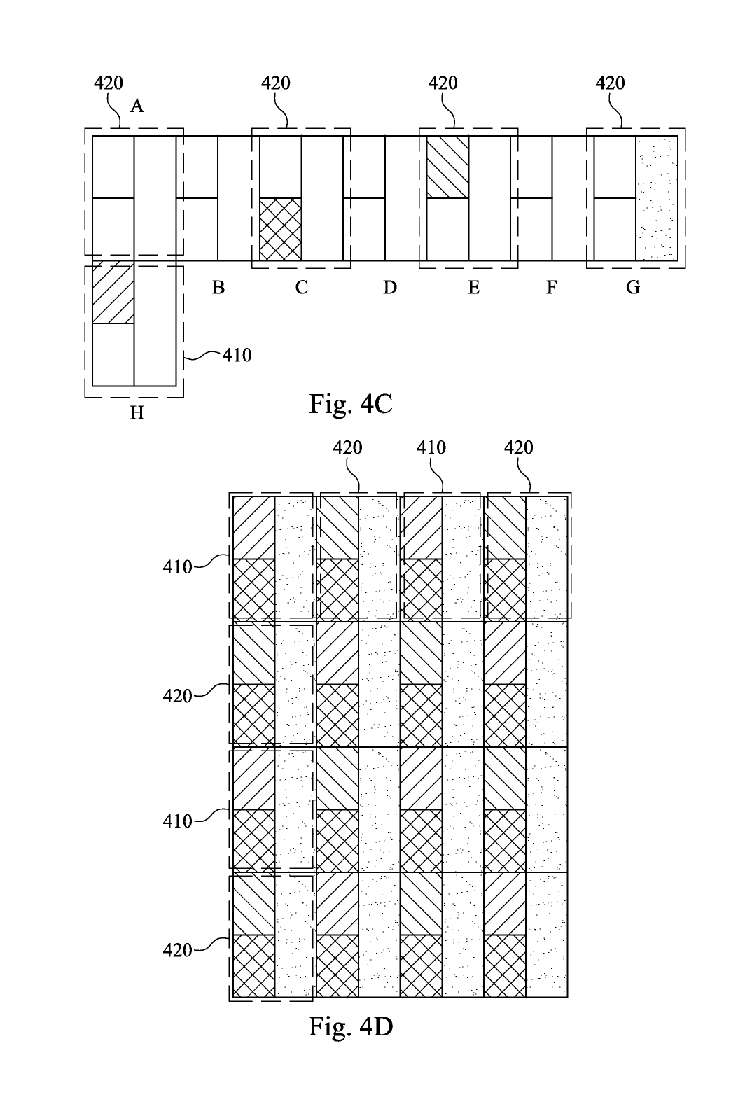

To resolve the problem(s) encountered by the prior art, embodiments of the present disclosure further provide another configuration of the pixel array 400, as illustrated in FIG. 4A. In contrast to the pixel array 300 illustrated in FIG. 3A, the unit pixels of the pixel array 400 are rotated counterclockwise 90 degrees, while the remaining arrangements are similar to those illustrated in FIG. 3A; hence, a detailed description thereof is omitted herein for the sake of brevity.

To describe the operating method of the first pixel 410 of the pixel array 400, FIG. 4B is provided for the purpose of illustration, in which the pixel array 400 is used to display various monochromes. As illustrated in FIG. 4B, parts A, C, E and G belong to the first pixel 410, whereas parts B, D, F and H belong to the second pixel 420. To facilitate the understanding of the operation of the present embodiment, only sub-pixels that are activated are illustrated herein, while the other non-active sub-pixels are presented as blank structures. With reference to parts A, C and G in FIG. 4B, when the first pixel 410 is designated to display the red color, green or the fourth colors, it may use the red, green and the fourth color sub-pixels R, G, W therewithin to respectively display said colors; however, when the first pixel 410 is designated to display the blue color, since the first pixel 410 itself does not comprise a blue sub-pixel B, in this case, with reference to part H, the second pixel 420 adjacent to the first pixel 410 uses the blue sub-pixel B of the second pixel 420 to display the blue color in a compensatory way.

Reference is now made to FIG. 4C which is used to describe the operation of the second pixel 420 of the pixel array 400 according to the present disclosure, in which parts A, C, E and G belong to the second pixel 420, whereas parts B, D, F and H belong to the first pixel 410. With reference to parts C, E and G in FIG. 4C, when the second pixel 420 is designated to display the green, blue and fourth colors, it may use the green, blue and the fourth color sub-pixels G, B, W therewithin to respectively display said colors; however, when the second pixel 420 is designated to display the red color, since the second pixel 420 itself does not comprise a red sub-pixel R, in this case, with reference to part H, the first pixel 410 adjacent to the second pixel 420 uses the red sub-pixel R of the first pixel 410 to display the blue color in a compensatory way. It should be noted that, in FIGS. 4B and 4C, since the first pixel 410 and the second pixel 420 are disposed adjacent to each other, users perceive little or no difference.

FIG. 4D schematically shows a pixel array 400 according to one embodiment of the present disclosure. As compared with the pixel array 300 illustrated in FIG. 3D, the unit pixels of the pixel array 400 are rotated counterclockwise 90 degrees, while the remaining arrangements are similar to those illustrated in FIG. 3D; hence, detailed description thereof is omitted herein for the sake of brevity.

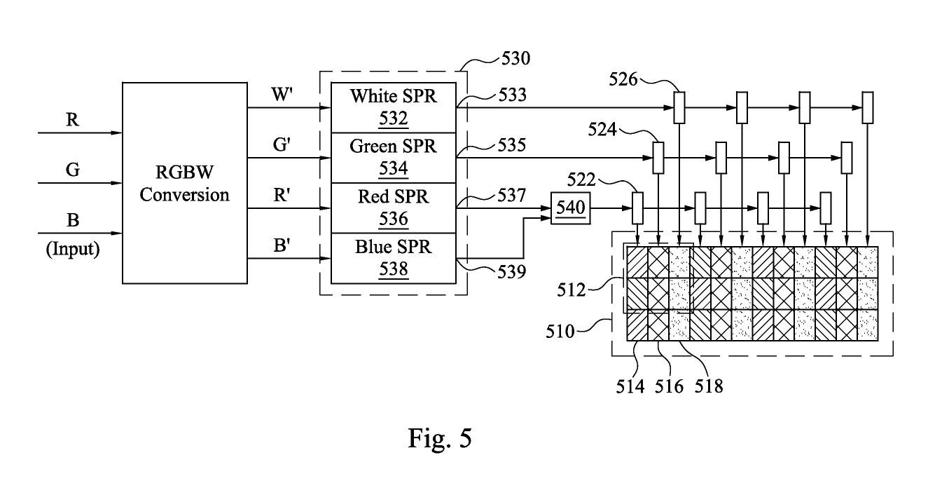

To resolve the problem(s) faced by the prior art, embodiments of the present disclosure further provide a display device, as illustrated in FIG. 5. As illustrated, the display device comprises a pixel array 510, first, second and third drivers 522, 524, 526, a sub-pixel colored circuit 530 and a multiplexer 540. More specifically, the pixel array 510 comprises a sub-pixel set 512 and first, second and third columns 514, 516, 518; the sub-pixel colored circuit 530 comprises first, second, third and fourth output terminals 533, 535, 537, 539; and the multiplexer 540 comprises an input terminal and an output terminal.

Structurally, the first to third drivers 522˜526 are respectively and electrically connected to the first to third columns 514˜518 of the pixel array 510; the first and second output terminals 533, 535 of the sub-pixel colored circuit 530 are respectively and electrically connected to the second and third drivers 524, 526; the third and fourth output terminals 537, 539 of the sub-pixel colored circuit 530 are electrically connected to the input terminal of the multiplexer 540; and the output terminal of the multiplexer 540 is electrically connected to the first driver 522.

As illustrated, the sub-pixel colored circuit 530 comprises four output terminals 533˜539 that output data via four data lines, in which third and fourth output terminals 537, 539 thereof are electrically connected to the multiplexer 540 via two data lines, and a data signal from the multiplexer 540 is outputted to the first driver 522. In this way, although the pixel array 510 of the display device comprises sub-pixels RGBW of four colors, the configuration of the display device only requires three drivers for driving said four sub-pixels RGBW. This configuration results in the reduction of one driver, which not only reduces manufacturing costs, but also effectively reduces the size of the unit pixel and improves the precision of the display device, thereby enhancing the displaying quality of the display device.

In the present disclosure, the second column 516 comprises the green sub-pixel G, and the third column 518 comprises the fourth color sub-pixel W. Specifically, the first to third drivers 522˜526 are, sequentially, electrically connected to the third column 514, second column 516 and first column 518. Moreover, the sub-pixel colored circuit 530 comprises a fourth color sub-pixel rendering unit (SPR) 532, a green sub-pixel rendering unit 534, a red sub-pixel rendering unit 536 and a blue sub-pixel rendering unit 538. The fourth color sub-pixel rendering unit 532 is electrically connected to the third driver 526 via the first output terminal 533, the green sub-pixel rendering unit 534 is electrically connected to the second driver 524 via the second output terminal 535, the red sub-pixel rendering unit 536 is electrically connected to the input terminal of the multiplexer 540 via the third output terminal 537, and the blue sub-pixel rendering unit 538 is electrically connected to the input terminal of the multiplexer 540 via the fourth output terminal 539.

However, the present disclosure is not limited to the configuration shown in FIG. 5. In another embodiment, the fourth color sub-pixel rendering unit 532 may also be electrically connected to the second driver 524 via the first output terminal 533, and the green sub-pixel rendering unit 534 may also be electrically connected to third driver 526 via the second output terminal 535. In the present embodiment, the second column 516 comprises the fourth color sub-pixel W, and the third column 518 comprises the green sub-pixel G. Additionally, the display device further comprises a converter 550 for converting the data signal representing the three colors of RGB into a data signal representing the four colors of RGBW.

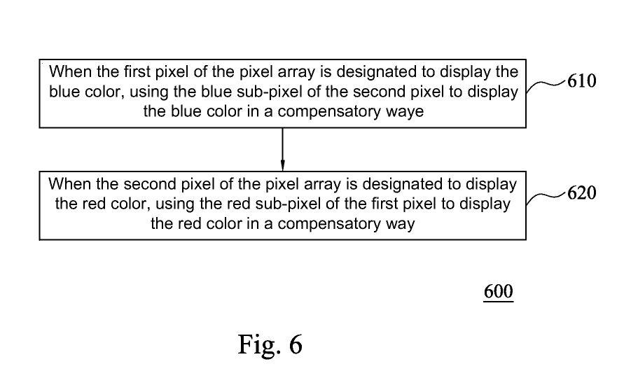

To solve the problems existing in the prior art, embodiments of the present disclosure also provide a color compensating method which is suitable for use in the above-discussed pixel array(s). The flow chart of said method is illustrated in FIG. 6. As illustrated, the color compensating method 600 comprises the following steps:

Step 610: when the first pixel of the pixel array is designated to display the blue color, using the blue sub-pixel of the second pixel to display the blue color in a compensatory way; and

Step 620: when the second pixel of the pixel array is designated to display the red color, using the red sub-pixel of the first pixel to display the red color in a compensatory way.

To further facilitate the understanding of the above-mentioned color to compensating method 600, reference is made to FIG. 1A for additional discussion of the color compensating method 600. With reference to both FIG. 1A and FIG. 6, in step 610, when the first pixel 110 of the pixel array 100 is designated to display the blue color, since the first pixel 110 does not comprise a blue sub-pixel B, in this case, the blue sub-pixel B of the second pixel 120 is used to display the blue color in a compensatory way. Further, with reference to step 620, when the second pixel 120 of the pixel array 100 is designated to display the red color, since the second pixel 120 does not comprise a red sub-pixel R, in this case, the red sub-pixel of the first pixel 110 is used to display the red color in a compensatory way. In this way, even if there are only three sub-pixels disposed in a unit pixel, the color compensating method 600 according to embodiments of the present disclosure may still display the image precisely, thereby maintaining the display quality of the display device.

With reference to FIG. 1A and FIG. 2A, the color compensating method 600 is suitable for use in the pixel arrays 100 and 200 illustrated in these drawings, wherein the sub-pixels of the first pixels 110, 210 are in the order of the red sub-pixel R, the green sub-pixel G and the fourth color sub-pixel W, or the red sub-pixel R, the fourth color sub-pixel W and the green sub-pixel G; whereas the sub-pixels of the second pixels 120, 220 are in the order of the blue sub-pixel B, the green sub-pixel G and the fourth color sub-pixel W, or the blue sub-pixel B, the fourth color sub-pixel W and the green sub-pixel G.

With reference to FIG. 3A and FIG. 4A, the color compensating method 600 is suitable for use in the pixel arrays 300 and 400 illustrated in these drawings, wherein first sub-pixel areas 312, 322, 412, 422 and the second sub-pixel areas 314, 324, 414, 424 respectively account for one-fourth of the area of the first pixels 310, 410 or the second pixels 320, 420; and third sub-pixel areas 316, 326, 416, 426 respectively account for one-half of the areas of the first pixels 310, 410 or the second pixels 320, 420.

With reference to FIG. 1A to FIG. 4A, the color compensating method 600 is suitable for use in the pixel arrays 100˜400 illustrated in these drawings, wherein the first pixels 110˜410 and the second pixel 120˜420 are disposed in a same row or a same column of the pixel arrays 100˜400.

With reference to FIGS. 1F, 2E, 3D and 4D, the color compensating method 600 is suitable for use in the pixel arrays 100˜400 illustrated in these drawings, wherein the pixel arrays 100˜400 comprise a plurality of first pixels 110˜410 and a plurality of second pixels 120˜420, the plurality of first pixels 110˜410 are repeatedly and alternately disposed in same row or a same column, and the plurality of second pixels 120˜420 are repeatedly and alternately disposed in a same row or a same column.

Those having skill in the art will appreciate that the color compensating method 600 can be performed with software, hardware, and/or firmware. For to example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the color compensating method 600 named after the function thereof is merely used to describe the technology in the embodiment of the present invention in detail, but the color compensating method 600 is not limited in this regard. Therefore, combining the steps of said method into one step, dividing the steps into several steps, or rearranging the order of the steps is within the scope of the embodiment in the present invention.

In view of the foregoing embodiments of the present invention, many advantages of the present invention are now apparent. The embodiment of the present invention provides a pixel array 100 that requires only three sub-pixels in a unit pixel, thereby effectively reducing the size of the unit pixel, which in turn improves the precision of the display device and consequently improves the display quality of the display device.

In addition, the embodiment of the present invention provides a display device that utilizes an innovative arrangement which requires only three drivers to drive four sub-pixels; as may be appreciated, the reduction of one driver not only reduces manufacturing costs, but also effectively reduces the size of the unit pixel, thereby improving the precision of the display device and the displaying quality of the display device. Moreover, the embodiments of the present disclosure provide a color compensating method 600, and by using said method, it is possible to accurately display an image even when there are only three sub-pixels in the unit pixel, and accordingly, the method is advantageous in maintaining the displaying quality of the display device.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A pixel array comprising:
a first pixel and a second pixel, wherein the first and second pixels are disposed adjacent to each other, and jointly comprise six sub-pixels, wherein the sub-pixels comprise one red sub-pixel, two green sub-pixels, one blue sub-pixel and two fourth color sub-pixels;
wherein the pixel area configuration of the first pixel is the same as the pixel area configuration of the second pixel, and the order of the sub-pixel areas to disposed therein is, sequentially, a first sub-pixel area, a second sub-pixel area, and a third sub-pixel area;
wherein the red sub-pixel is disposed in the first sub-pixel area of the first pixel, and the blue sub-pixel is correspondingly disposed in the first sub-pixel area of the second pixel.

2. The pixel array according to claim 1, wherein the first pixel comprises the sub-pixels in the order of the red sub-pixel, the green sub-pixel and the fourth color sub-pixel, and the second pixel comprises the sub-pixels in the order of the blue sub-pixel, the green sub-pixel and the fourth color sub-pixel.

3. The pixel array according to claim 1, wherein the first pixel comprises the sub-pixels in the order of a red sub-pixel, a fourth color sub-pixel and a green sub-pixel, and the second pixel comprises the sub-pixels in the order of a blue sub-pixel, a fourth color sub-pixel and a green sub-pixel.

4. The pixel array according to claim 1, wherein the first sub-pixel area and the second sub-pixel area is spaced by a half pitch.

5. The pixel array according to claim 1, wherein the first sub-pixel area and the second sub-pixel area respectively account for one-fourth of the area of the first pixel and one-fourth the area of the second pixel, and the third sub-pixel area accounts for one-half of the area of the first pixel or the area of the second pixel.

6. The pixel array according to claim 5, wherein the second sub-pixel area and the third sub-pixel area of the first pixel are respectively disposed with a green sub-pixel and a fourth color sub-pixel, and the second sub-pixel area and the third sub-pixel area of the second pixel are respectively disposed with a green sub-pixel and a fourth color sub-pixel.

7. The pixel array according to claim 1, wherein the first pixel and the second pixel are disposed in the same row or same column of the pixel array.

8. The pixel array according to claim 1, further comprising a plurality of the first pixels and a plurality of the second pixels, wherein the plurality of the first pixels are repeatedly and alternately disposed in a same row or a same column, and the plurality of the second pixels are repeatedly and alternately disposed in a same row or a same column.

9. A display device comprising:
a pixel array comprising a sub-pixel set and a first to a third column, to wherein the sub-pixel set comprises six sub-pixels, and the sub-pixels comprises one red sub-pixel, two green sub-pixels, one blue sub-pixel and two fourth color sub-pixels, wherein the first column comprises the red sub-pixel and the blue sub-pixel;
a first to a third driver, respectively and electrically connected to the first to the third column of the pixel array;
a sub-pixel colored circuit comprising a first to a fourth output terminal, wherein the first and the second output terminals are respectively and electrically connected to the second and the third drivers; and
a multiplexer comprising an input terminal and an output terminal, wherein the third and the fourth output terminals of the sub-pixel colored circuit are electrically connected to the input terminal of the multiplexer, and the output terminal of the multiplexer is electrically connected to the first driver.

10. The display device according to claim 9, wherein the second column comprises the green sub-pixel or the fourth color sub-pixel, and the third column comprises the green sub-pixel or the fourth color sub-pixel.

11. The display device according to claim 10, wherein the first to the third driver are sequentially and electrically connected to the third column, the second column and the first column, wherein the sub-pixel colored circuit comprises:
a fourth color sub-pixel rendering unit electrically connected to one of the second and third drivers via the first output terminal;
a green sub-pixel rendering unit electrically connected to the other one of the second and third drivers via the second output terminal;
a red sub-pixel rendering unit electrically connected to the input terminal of the multiplexer via the third output terminal; and
a blue sub-pixel rendering unit electrically connected to the input terminal of the multiplexer via the fourth output terminal.

12. A color compensating method for use in the pixel array according to claim 1, wherein the color compensating method comprises:
when the first pixel of the pixel array is designated to display the blue color, using the blue sub-pixel of the second pixel to display the blue color in a compensatory way; and
when the second pixel of the pixel array is designated to display the red color, using the red sub-pixel of the first pixel to display the red color in a compensatory way.

13. The color compensating method according to claim 12, wherein the first pixel comprises the sub-pixels in the order of a red sub-pixel, a green sub-pixel and a fourth color sub-pixel, or a red sub-pixel, a fourth color sub-pixel and a green sub-pixel, and the second pixel comprises the sub-pixels in the order of blue sub-pixel, a green sub-pixel and a fourth color sub-pixel, or a blue sub-pixel, a fourth color sub-pixel and a green sub-pixel.

14. The color compensating method according to claim 12, wherein the first sub-pixel area and the second sub-pixel area respectively account for one-fourth of the area of the first pixel and one-fourth the area of the second pixel, and the third sub-pixel area accounts for one-half of the area of the first pixel or the area of the second pixel.

15. The color compensating method according to claim 12, wherein the first pixel and the second pixel are disposed in a same row or a same column of the pixel array.

16. The color compensating method according to claim 12, wherein the pixel array comprises a plurality of the first pixels and a plurality of the second pixels, wherein the plurality of the first pixels are repeatedly and alternately disposed in a same row or a same column, and the plurality of the second pixels are repeatedly and alternately disposed in a same row or a same column.
